(19) United States
(12) Patent Application Publication
(10) Pub. No.: US 2025/0042681 A1
(43) Pub. Date: Feb. 6, 2025

(54) DRIVE SWITCHING MECHANISM AND IMAGE PRINTING APPARATUS

(71) Applicant: CANON KABUSHIKI KAISHA, Tokyo (JP)

(72) Inventors: KATSUAKI SUKEGAWA, Kanagawa (JP); MASAKAZU TSUKUDA, Kanagawa (JP)

(21) Appl. No.: 18/778,953

(22) Filed: Jul. 20, 2024

(30) Foreign Application Priority Data
Jul. 31, 2023 (JP) 2023-124481

(51) Int. Cl. B65H 3/06; F16H 37/04

(52) U.S. Cl. CPC B65H 3/0669; F16H 37/04; B65H 2403/481

(57) ABSTRACT

Provided are a drive switching mechanism and an image printing apparatus that can downsize the apparatus. To this end, a configuration in which orbiting movement of a planetary gear is not restricted in a region other than a region from a first position to a second position during a drive switching operation is applied.

### BACKGROUND OF THE INVENTION

### Field of the Invention

The present invention relates to a drive switching mechanism and an image printing apparatus.

### Description of the Related Art

There has been known a drive switching mechanism that selectively distributes and transmits driving force of a single driving source to multiple mechanisms. Japanese Patent Laid-Open No. 2009-274304 discloses a drive switching mechanism in which a motive power transmission unit including an arm member along an axial direction of a drive shaft moves between a first position in which rotation torque is transmitted and a second position in which a driven unit to which the rotation torque is transmitted is selected. Japanese Patent Laid-Open No. 2009-274304 describes the drive switching mechanism that includes a middle position that is between the first position and the second position in which the rotation torque is not transmitted to either the driven unit or the arm member. Japanese Patent Laid-Open No. 2009-274304 describes the drive switching mechanism that can return from the middle position to the first position by moving the motive power transmission unit from the middle position to the second position.

However, in the apparatus described in Japanese Patent Laid-Open No. 2009-274304, an orbiting operation of a planetary arm is constrained in the second position in a path in which the motive power transmission unit returns from the middle position to the first position. Additionally, in a case of switching the driven unit to which the drive is transmitted, it is necessary to further move the motive power transmission unit in the axial direction of the drive shaft to release the constrained orbiting operation of the planetary arm in the second position. As a result, the drive switching mechanism has been large in a motive power axis direction, and it has been difficult to achieve downsizing.

### SUMMARY OF THE INVENTION

Therefore, the present invention provides a drive switching mechanism and an image printing apparatus that can downsize the apparatus.

Therefore, a drive switching mechanism of the present invention is a drive switching mechanism, including: a drive shaft that is rotated by a driving source; a driven unit that includes a fixing shaft to which driving force of the drive shaft is transmitted; a drive switching unit that switches transmission of the driving force of the drive shaft to the driven unit by being moved in a thrust direction of the drive shaft; and a planetary gear that is provided to the drive switching unit, can orbit around the drive shaft in a case of not being engaged with the fixing shaft, and can transmit the driving force of the drive shaft to the driven unit while being engaged with the fixing shaft, in which the drive switching unit can be moved to a first position in which the driving force of the drive shaft is transmitted to the driven unit while being engaged with the fixing shaft, a second position in which the driving force of the drive shaft is not transmitted to the driven unit while being engaged with the fixing shaft, and a third position in which the planetary gear can orbit while not being engaged with the fixing shaft, and the drive switching unit passes through the third position in a case where the planetary gear is not allowed to orbit while moving from the second position to the first position.

According to the present invention, it is possible to provide a drive switching mechanism and an image printing apparatus that can downsize the apparatus.

Further features of the present invention will become apparent from the following description of exemplary embodiments with reference to the attached drawings.

### BRIEF DESCRIPTION OF THE DRAWINGS

FIG. 1 is a perspective view illustrating an internal configuration of an image printing apparatus including a drive transmission mechanism;

FIG. 2 is a block diagram of the image printing apparatus;

FIG. 3 is a side view illustrating inside of the image printing apparatus;

FIGS. 4A and 4B are perspective views illustrating a driving unit of the image printing apparatus;

FIGS. 5A and 5B are perspective views illustrating a drive switching mechanism;

FIGS. 6A to 6C are diagrams illustrating a drive switching position in a drive switching unit;

FIGS. 7A to 7D are diagrams illustrating a drive switching operation to return from a second position to a first position;

FIGS. 8A to 8D are diagrams illustrating the drive switching unit;

FIGS. 9A to 9C are diagrams illustrating the drive switching unit through which a fixing shaft is inserted;

FIGS. 10A to 10C are perspective views illustrating a portion causing oscillation; and

FIG. 11 is a table illustrating a list of oscillation components.

### DESCRIPTION OF THE EMBODIMENTS

Embodiments of the present invention are described below with reference to the drawings.

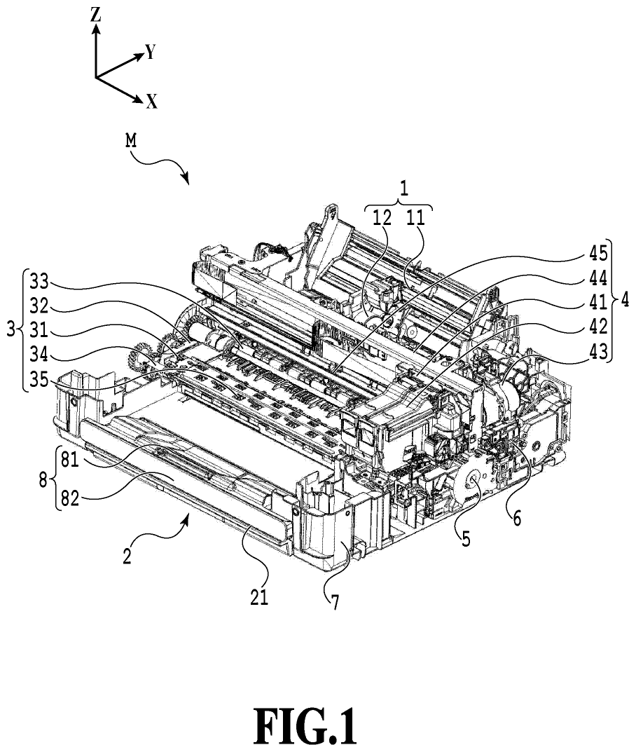

FIG. 1 is a perspective view illustrating an internal configuration of an image printing apparatus M including a drive transmission mechanism in the present embodiment. The image printing apparatus M is a multifunctional peripheral including a printing unit and a scanner unit (not illustrated) arranged on the printing unit and can execute various types of processing related to an image printing operation and a reading operation by the printing unit and the scanner unit individually or in conjunction with each other. The scanner unit includes an automatic document feeder (ADF) and a flatbed scanner (FBS) and can read an original document automatically fed by the ADF and read (scan) the original document put on an original document plate of the FBS by a user. Note that, although the present embodiment describes the multifunctional peripheral including the printing unit and the scanner unit together as an example, a mode of not including the scanner unit may be applied.

The printing unit includes a first feeding unit 1, a second feeding unit 2, a conveyance unit 3, a printing unit 4, a maintenance unit 5, a driving unit 6, and a discharge unit 8. The user stacks printing media before printing is performed thereon on the first feeding unit 1 and the second feeding unit 2. The conveyance unit 3 accurately conveys the printing medium fed from each feeding unit to a printable position. The printing unit 4 prints an image on the printing medium conveyed by the conveyance unit 3. The maintenance unit 5 performs maintenance of the printing unit 4. The driving unit 6 uses a drive of a conveyance motor 31 included in the conveyance unit 3 to switch and transmit the drive to any one of the first feeding unit 1, the second feeding unit 2, and the maintenance unit 5. The discharge unit 8 includes a printing medium stacking unit 81 and an extending tray 82 that can be drawn from the image printing apparatus M so as to be able to support the printing medium even in a case where the size of the printing medium is great. All those units are fastened to a base 7 and form the printing unit.

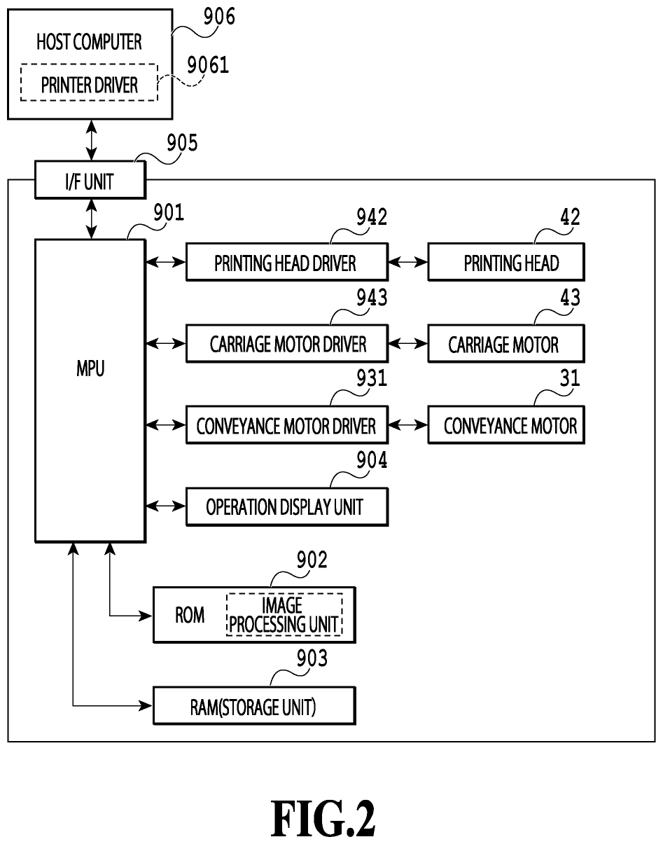

FIG. 2 is a block diagram of the image printing apparatus M in the present embodiment. An MPU 901 controls an operation of each unit, processing of data, and the like. A ROM 902 stores a program and data executed by the MPU 901. A RAM 903 temporarily stores the processing data executed by the MPU 901 and data received from a host computer 906. A printing head 42 is controlled by a printing head driver 942.

A carriage 41 is driven by a carriage motor 43. The carriage motor 43 is controlled by a carriage motor driver 943. A conveyance roller 32 and a discharge roller 34 are driven by the conveyance motor 31. The conveyance motor 31 is controlled by a conveyance motor driver 931. The host computer 906 includes a printer driver 9061 that communicates with the image printing apparatus M by processing printing information such as a printing image and an image quality in a case where execution of the printing operation is instructed by the user. The MPU 901 transmits and receives the printing image and the like to and from the host computer 906 via an I/F unit 905.

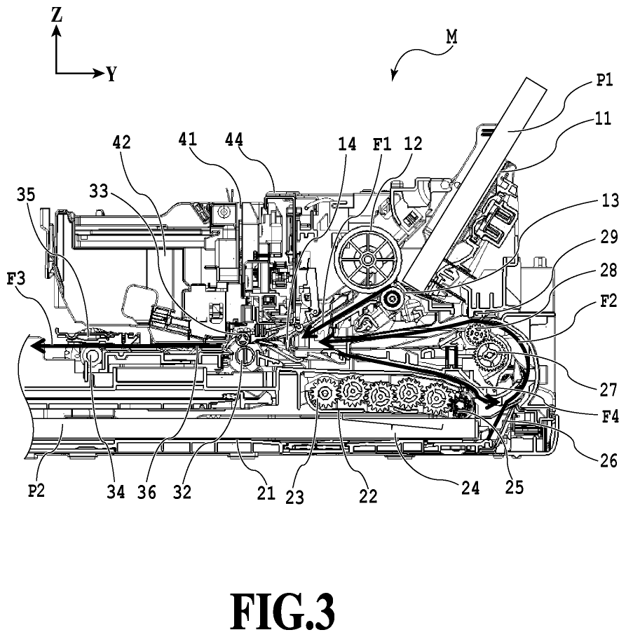

FIG. 3 is a side view illustrating inside of the image printing apparatus M in the present embodiment. A series of procedure of printing an image on the printing medium by the image printing apparatus M is described with reference to FIG. 3. There are two methods described below in a case where the user sets the printing medium on which an image is printed. In the first method, a printing medium P1 is set on the first feeding unit 1 by stacking the printing medium P1 on a pressure plate 11. In the second method, the printing medium P2 is set on the second feeding unit 2 by stacking a printing medium P2 on a cassette case 21 attachable and detachable to and from the image printing apparatus M and mounting the cassette case 21 on the image printing apparatus M.

Once the user inputs the printing information and gives instruction to the image printing apparatus M to perform printing, the conveyance motor 31 (see FIG. 1) starts forward rotation. In a case where the printing medium P1 is fed from the first feeding unit 1, the driving unit 6 and the first feeding unit 1 are drivingly connected to each other. Feeding is started with the pressure plate 11 being put in contact with a first feeding roller 12 that is rotated by receiving the drive of the conveyance motor 31. In a position facing the first feeding roller 12, a separation roller 13 that provides a resistance in a feeding direction of the printing medium P1 is arranged, and only the uppermost paper of the printing media P1 stacked on the pressure plate 11 is fed to the conveyance unit 3 by the separation roller 13 as indicated by an arrow F1.

Additionally, in a case where the printing medium P2 is fed from the second feeding unit 2, the driving unit 6 and the second feeding unit 2 are drivingly connected to each other. The drive of the conveyance motor 31 is transmitted to a second feeding shaft gear 23 via the driving unit 6. A second feeding roller 25 is rotated via the second feeding shaft gear 23 to multiple second feeding idle gears 24 and feeds only the uppermost paper of the printing media P2 stacked on the cassette case 21. A separation unit 26 that provides a resistance to the fed printing medium P2 in the feeding direction is provided, and thus the uppermost paper that is put in contact with the second feeding roller 25 is fed by the separation unit 26 even in a case where the multiple printing media P2 are fed. Next, the drive is transmitted to a middle gear 27 and a middle roller 28 via a not-illustrated gear drive train of the driving unit 6. A driven roller 29 is arranged in a position facing the middle roller 28 and feeds the printing medium P2 fed from the second feeding roller 25 to the conveyance unit 3 as indicated by an arrow F2.

Once the printing medium fed from each feeding unit passes through a detection lever 14, a conveyance roller pair of the conveyance roller 32 and a pinch roller 33 driven with the conveyance roller 32 align positions of right and left tip portions of the printing medium in a width direction with respect to a conveyance direction.

The printing unit 4 includes the carriage 41 on which the printing head 42 is mounted, a chassis 44 that supports the carriage 41, and a chassis rail 45. The carriage 41 reciprocally moves in a scanning direction crossing perpendicularly to the conveyance direction of the fed printing medium. On the printing medium conveyed by the conveyance roller pair, an image is printed by an ink ejected from the printing head 42 during scanning by the carriage 41 while the printing medium passes over a platen 36 that is provided in a position facing the printing unit 4 and biases the printing medium. In a case of printing an image on only one side of the printing medium, the printing medium is discharged to the discharge unit 8 through a discharge roller pair of the discharge roller 34 and a spur 35 as indicated by an arrow F3, and printing ends.

In a case of printing an image on two sides of the printing medium, after printing of an image on one side of the printing medium is completed, the conveyance motor 31 is rotated reversely from a state in which a rear end of the printing medium is pinched. Accordingly, the discharge roller pair and the conveyance roller pair are rotated reversely from the conveyance direction in which an image is printed, and it is possible to convey the printing medium in a reversal conveyance path as indicated by an arrow F4. Once the printing medium rear end in the conveyance direction passes through the conveyance roller pair, the conveyance motor 31 is switched to the forward rotation, and the positions of the right and left tip portions in the printing medium width direction are aligned again by the conveyance roller pair. Thereafter, an operation to print an image on the other side of the printing medium is performed, and the printing medium on which an image is printed is discharged to the discharge unit 8 through the discharge roller pair of the discharge roller 34 and the spur 35 as indicated by the arrow F3.

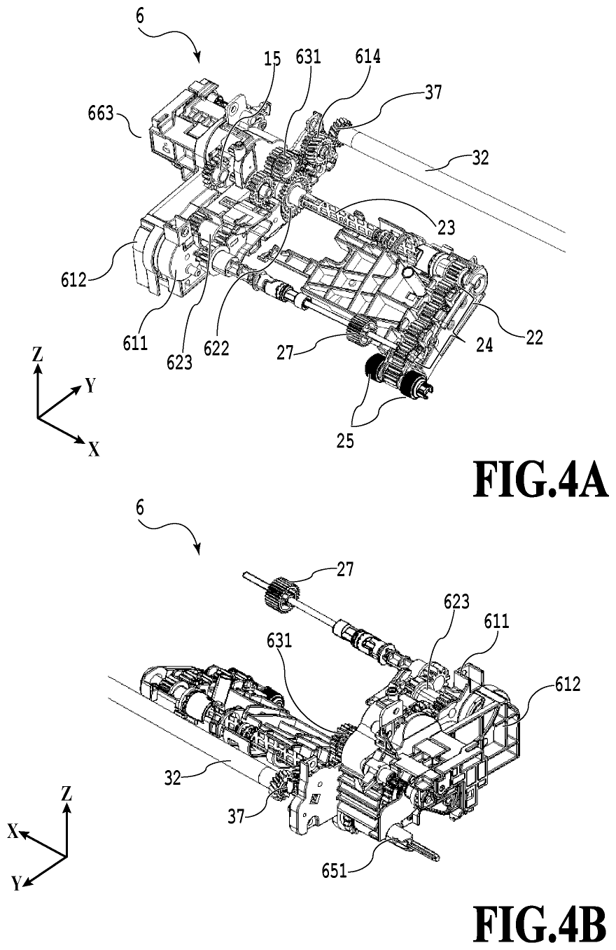

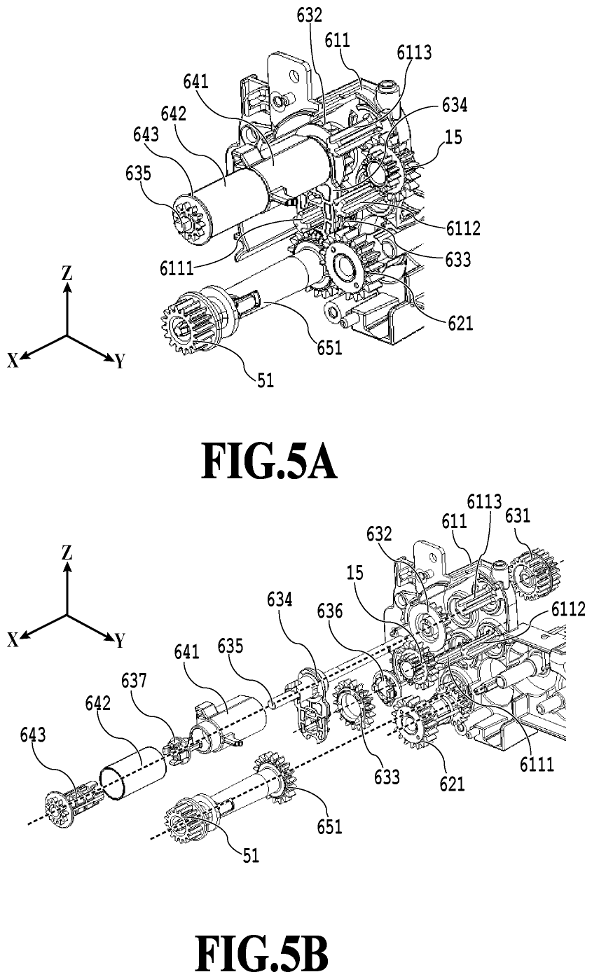

FIGS. 4A and 4B are perspective views illustrating the driving unit 6 of the image printing apparatus M in the present embodiment, and FIGS. 5A and 5B are perspective views illustrating a drive switching unit in the driving unit 6. FIG. 5A illustrates a drive switching mechanism after assembling, and FIG. 5B illustrates the drive switching unit before assembling.

The drive of the conveyance motor 31 (see FIG. 1) is transmitted to the driving unit 6 via a conveyance roller output gear 37 that is rotated integrally with the conveyance roller 32. The driving unit 6 includes a drive input gear 614 that meshes with the conveyance roller output gear 37, a drive base 611 that holds multiple gears that transmits the drive to multiple driven units provided, a drive cover 612, and a positioning unit 663 that performs positioning of the drive switching unit. The drive is transmitted to a sun gear 631 from the drive input gear 614 via the multiple gears.

The sun gear 631 and a sun gear 632 are fitted to a drive shaft 635 in a D-cut shape and rotated integrally. A planetary gear 633 can transmit driving force, meshes (engages) with the sun gear 632, and functions as a planetary gear mechanism. A planetary arm 634 that holds the planetary gear 633 has a configuration rotatable about the same axis as the drive shaft 635 and movable in a thrust direction. In addition, a trigger holder 641, a trigger holder spring 642, and a drive shaft gear 643 are arranged on the same axis as the drive shaft 635. The drive shaft gear 643 is fitted to the drive shaft 635 in a D-cut shape and rotated integrally. The trigger holder 641 can be displaced in the thrust direction of the drive shaft 635, and the planetary arm 634 is also synchronized in conjunction with the movement in the thrust direction. Additionally, the planetary arm 634 and the drive shaft 635 are coupled to each other by a coupling member 637, and thus the planetary arm 634 can orbit about the drive shaft 635.

The drive shaft 635 is rotatably supported by the drive base 611 and the drive cover 612 and is arranged parallel to the scanning direction of the carriage 41. The drive switching unit includes the sun gear 632, the planetary gear 633, the planetary arm 634, an introduction member 636, and the trigger holder 641. The drive switching unit is constantly biased in a −x direction by the trigger holder spring 642.

The drive base 611 includes a first fixing shaft 6111, a second fixing shaft 6112, and a third fixing shaft 6113. These fixing shafts are arranged on an orbiting trajectory of the planetary gear 633 with respect to the planetary arm 634. A shaft hole into which the fixing shaft can be inserted is formed in each of the planetary arm 634 and the introduction member 636, and the orbiting of the planetary arm 634 is restricted once the fixing shaft is inserted in the shaft hole. After the fixing shaft is inserted in the planetary arm 634, multiple driving input gears are each arranged around the fixing shaft so as to transmit the drive to each driving unit.

In a case where the first fixing shaft 6111 is inserted in the shaft holes of the planetary arm 634 and the introduction member 636, a maintenance input gear 651 and the planetary gear 633 mesh with each other. In a case where the second fixing shaft 6112 is inserted, a second feeding input gear 621 and the planetary gear 633 mesh with each other. In a case where the third fixing shaft 6113 is inserted, a first feeding input gear 15 and the planetary gear 633 mesh with each other. With the input gear of each driving unit and the planetary gear 633 meshing with each other, it is possible to transmit the drive to each driving unit.

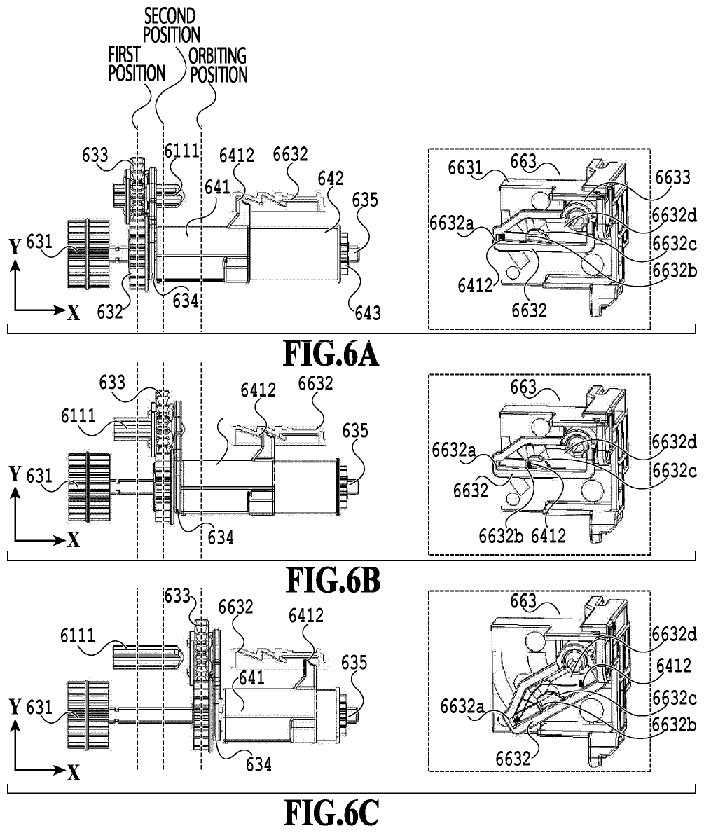

FIGS. 6A to 6C are diagrams illustrating a drive switching position in the drive switching unit of the present embodiment. In side views of FIGS. 6A to 6C, parts other than the moving gear are illustrated such that the positions thereof in an X direction are aligned so as to be able to compare the positions of the gears during drive switching. Additionally, there is also illustrated a perspective view of a clutch 6632 portion corresponding to a state of each side view.

A locking unit 6412 is provided to the trigger holder 641 so as to be able to lock the drive switching unit in multiple positions in the thrust direction of the drive shaft 635, and the positioning unit 663 is provided to the driving unit 6 to be engaged with the locking unit 6412. The positioning unit 663 includes the clutch 6632 that holds a position of the drive shaft 635 in the axis direction by being engaged with the locking unit 6412 and a clutch spring 6633 that generates bias to prevent separation between the locking unit 6412 and the clutch 6632. Additionally, the positioning unit 663 includes a clutch holder 6631 that holds the clutch 6632 and the clutch spring 6633. Note that, although the first fixing shaft 6111 is illustrated as the fixing shaft in the drawings after FIG. 6C, the same applies to the second fixing shaft 6112 and the third fixing shaft 6113.

FIG. 6A illustrates a state in which the drive switching unit is positioned in a first position. In a position in which the locking unit 6412 is engaged with a first locking unit 6632a provided to the clutch 6632, any one of the first to third fixing shafts is inserted into the shaft holes of the planetary arm 634 and the introduction member 636, and the orbiting of the planetary arm 634 is constrained. Then, according to the inserted fixing shaft, the drive switching unit connects the first feeding unit 1, the second feeding unit 2, or the maintenance unit 5 with the drive shaft.

FIG. 6B illustrates a state in which the drive switching unit is positioned in a second position in a movement path from the first position. The drive switching unit is displaced by a predetermined amount by the carriage 41 in the thrust direction of the drive shaft 635, and thus the drive switching unit is locked in a position in which the locking unit 6412 is engaged with a second locking unit 6632b provided to the clutch 6632. As with the first position, the orbiting of the planetary arm 634 is constrained by any fixing shaft. Additionally, unlike the first position, each input gear of the first feeding unit 1, the second feeding unit 2, or the maintenance unit 5 and the planetary gear 633 of the drive switching unit are in a non-connection state.

A state in which the drive switching unit is positioned in the second position is used in a case of stopping the feeding of a last piece of the printing medium from the first feeding unit 1 and the second feeding unit 2 by the printing instruction, for example. In the present embodiment, a configuration in which a drive connection state is obtained in a case where the drive switching unit is positioned in the first position, and the non-connection state is obtained in a case where the drive switching unit is positioned in the second position is applied; however, a configuration in which the non-connection state of the drive switching unit is obtained in the first position, and the connection state is obtained in the second position may be applied.

FIG. 6C illustrates a state in which the first fixing shaft is removed from the shaft holes of the planetary arm 634 and the introduction member 636, and the planetary arm 634 is positioned in an orbiting position (hereinafter, also referred to as a third position) that allows for orbiting. It is a state in which the carriage 41 further pushes (moves) the drive switching unit by a predetermined amount from the second position in the thrust direction of the drive shaft 635. In a case where the locking unit 6412 is positioned in a +X direction from a slope 6632c provided to the clutch 6632, the clutch 6632 is pivoted counterclockwise as indicated by an arrow by a slope 6632d and the clutch spring 6633. A portion from the slope 6632d to the first locking unit 6632a in which the arrow passes through is formed of multiple curved surfaces. The locking unit 6412 is moved as indicated by the arrow and consequently positioned in the first locking unit 6632a, and the state returns to FIG. 6A. That is, the drive switching unit returns to the first position from the second position by way of the third position (orbiting position).

As illustrated in FIG. 6C, in the orbiting position of the planetary arm 634 while being pressed by the carriage 41, the planetary gear orbits by forward and reverse rotation operations of a driving source, and it is possible to arrange the planetary gear on a substantially same axis as each fixing shaft. With the carriage 41 being retracted in this state, the predetermined fixing shaft 6111 is inserted through the shaft holes of the planetary gear 633 and the planetary arm 634.

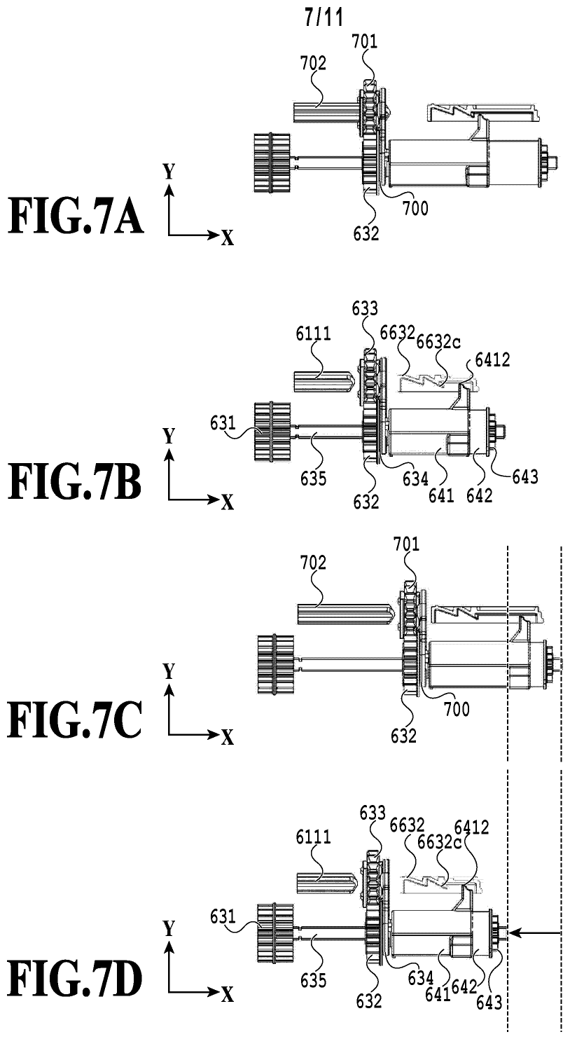

FIGS. 7A to 7D are diagrams describing a state in which the drive switching unit is moved for the drive switching by comparing a conventional configuration to a configuration of the present embodiment. FIGS. 7A and 7B are diagrams illustrating a state in which the drive switching unit returns from the second position to the first position without switching the drive in the conventional configuration and in the present embodiment, respectively. In the present embodiment illustrated in FIG. 7B, the drive switching unit is in the above-described third position, that is, the position in which the planetary gear 633 of the drive switching unit can orbit.

On the other hand, FIGS. 7C and 7D are diagrams illustrating a state in which the drive switching unit is in the orbiting position and can switch the drive in the conventional configuration and in the present embodiment, respectively. Note that, in the present embodiment, FIG. 7B illustrating a case of returning from the second position to the first position and FIG. 7D illustrating the orbiting position are the same.

In other words, in the conventional configuration, there are a position for the drive switching unit to return from the second position to the first position and the orbiting position for performing an orbiting operation. Here, the position of the conventional configuration illustrated in FIG. 7A is a middle position. This middle position is a position for the drive switching unit to return from the second position to the first position and is a position in which the drive switching unit is moved within the same fixing shaft in a case where the drive switching unit returns from the second position to the first position. In this position, it is possible to return from the second position to the first position without switching the drive.

In the conventional configuration, in the middle position illustrated in FIG. 7A, a first fixing shaft 702 is inserted in shaft holes of a planetary arm 700 and a planetary gear 701, and the orbiting movement of the planetary arm 700 is restricted. Note that, in the middle position of the conventional configuration, no motive power to allow the planetary arm 700 to orbit is transmitted. In the conventional configuration, the movement from the middle position to the orbiting position (see FIG. 7C) allows the first fixing shaft 702 to be removed from the shaft holes of the planetary arm 700 and the planetary gear 701, and the planetary arm 700 can orbit. In the orbiting position of the conventional configuration, the motive power that allows the planetary arm 700 to orbit is transmitted.

On the other hand, in the present embodiment, in a position other than the first position and the second position (other than a region from the first position to the second position), the first fixing shaft 6111 is removed from the shaft holes of the planetary arm 634 and the planetary gear 633, and the orbiting of the planetary arm 634 is not restricted. That is, in the present embodiment, in a path in which the planetary gear is returned from the second position to the first position without orbiting, there is the third position (the orbiting position) in which the first fixing shaft is removed from the shaft holes of the planetary arm 634 and the introduction member 636. Accordingly, in the path of returning from the second position to the first position, an operation to move the planetary gear 633 in the +X direction from the third position to move the shaft holes of the planetary arm 634 and the planetary gear 633 away from the first fixing shaft 6111 like the conventional configuration is unnecessary. Therefore, according to the configuration of the present embodiment, it is possible to downsize the apparatus by an amount indicated by an arrow illustrated in FIG. 7D.

In the conventional configuration, between the middle position and the orbiting position, an operation to remove the fixing shaft 702 from the shaft holes of the planetary arm 700 and the planetary gear 701 and an operation to mesh gears to transmit the motive power for the orbiting of the planetary arm 700 are performed. The order of the operations is: after the gears mesh with each other, the fixing shaft 702 is removed from the shaft holes. In this process, since the planetary arm 700 can orbit after the gears mesh with each other, there is a possibility that the planetary arm 700 orbits by an amount of a tooth of the gear in a timing of meshing of the gears. In a case where the position of the planetary arm 700 is displaced due to the orbiting, there is a possibility that the fixing shaft 702 cannot be inserted into the shaft holes of the planetary arm 700 and the planetary gear 701 in a case of returning to the first position. Therefore, until the gears mesh with each other, the shaft holes of the planetary arm 700 and the planetary gear 701 are fixed by the fixing shaft 702 to prevent unintentional orbiting of the planetary arm 700 while the gears mesh with each other.

Therefore, the present embodiment has a configuration that suppresses failures in insertion of the fixing shaft 6111 into the shaft holes of the planetary arm 634 and the planetary gear 633 in a case of returning from the second position to the first position. Hereinafter, in the present embodiment, the configuration that suppresses failures in insertion of the fixing shaft 6111 into the shaft holes of the planetary arm 634 and the planetary gear 633 in a case of returning from the second position to the first position is described.

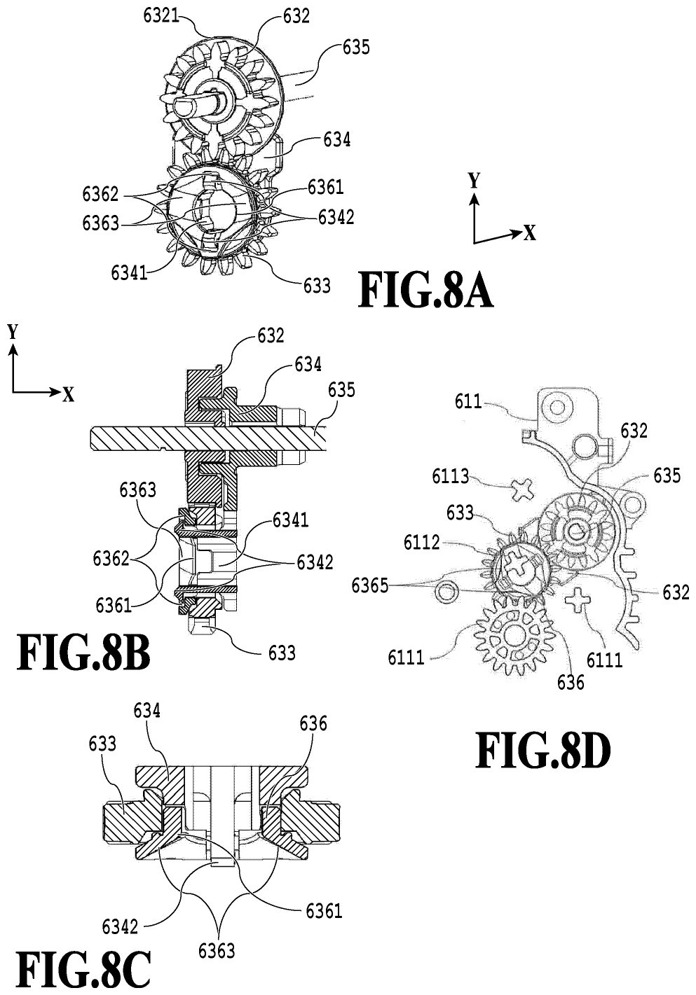

FIG. 8A is a perspective view illustrating the vicinity of the sun gear 632 and the planetary gear 633 in the present embodiment, and FIG. 8B is a cross-sectional view thereof. Additionally, FIG. 8C is a cross-sectional view of the introduction member 636, and FIG. 8D is a front view of the drive switching unit in a state in which a shaft hole 6341 (see FIG. 8A) of the planetary arm 634 and the fixing shaft 6111 are not coaxial. The sun gear 632, the planetary gear 633, and the introduction member 636 are assembled to the planetary arm 634. As illustrated in FIG. 8A, a flange 6321 prevents the sun gear 632 from being removed from the planetary arm 634 in the x direction. Additionally, a configuration in which removal in the −x direction is prevented by fitting between a groove portion 6362 provided to the introduction member 636 and a hook portion 6342 of the planetary arm, and thus detaching of each part from the planetary arm 634 is prevented is applied.

The planetary gear 633 is fitted to the planetary arm 634 and transmits the drive to each driving unit by receiving the transmission of the drive from the sun gear 632. Additionally, for the insertion of the fixing shaft 6111, the shaft hole 6341 is provided in the planetary arm 634 (see FIG. 8A), and a shaft hole 6361 is provided in the introduction member 636, respectively (see FIG. 8C). The introduction member 636 is fitted to the planetary arm 634, and the shaft hole 6341 and the shaft hole 6361 are formed to be substantially coaxial.

As illustrated in FIG. 8C, an introduction surface 6363 having an inclined shape (an inclined portion) that is narrowed in an insertion direction of the fixing shaft 6111 is provided to the introduction member 636. Thus, even in a case where the drive switching unit is inserted in different fixing shafts, and the shaft hole 6361 of the introduction member 636 and the fixing shaft are not coaxial, the drive switching unit is rotated by using the inclination of the introduction surface 6363, and thus the fixing shaft is inserted in the shaft hole 6361. Additionally, a diameter of an outline portion 6364 of the introduction member 636 is formed to be smaller than a diameter of a teeth bottom circle of the planetary gear 633. With this configuration, the introduction member 636 never disturb the meshing between the planetary gear 633 and the driving input gear in a case where the drive switching unit is moved from the orbiting position (the third position) to the first position. In addition, the introduction member 636 includes a notch portion 6365 (see FIG. 8D). The notch portion 6365 is formed to prevent interference between the driving input gear and the introduction member 636 that disturbs the insertion of the fixing shaft into the shaft hole 6361 in the process of inserting the fixing shaft into the shaft hole 6361 by using the inclination of the introduction surface 6363.

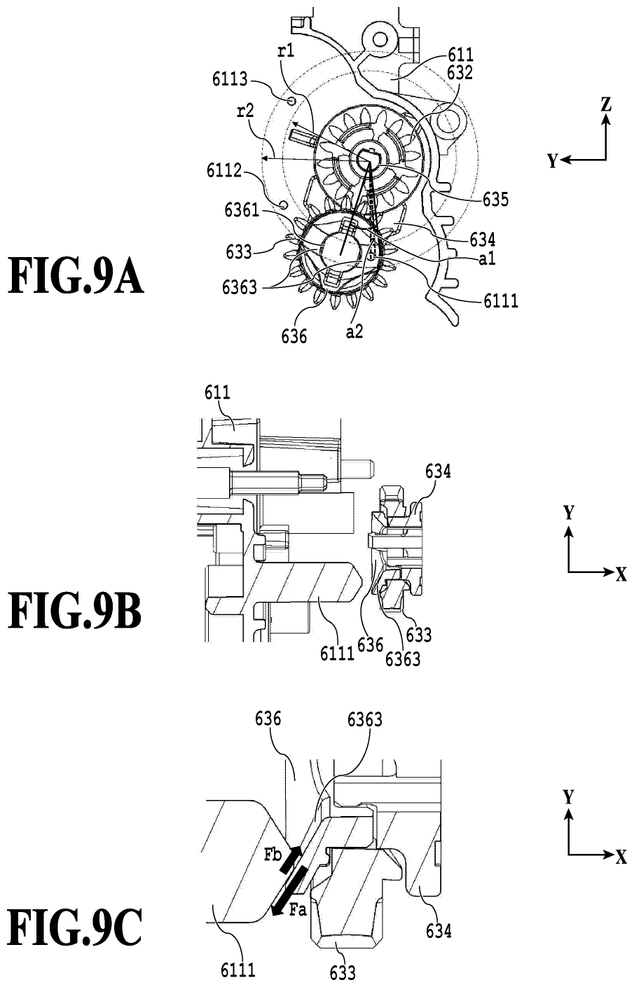

FIGS. 9A to 9C are diagrams illustrating the drive switching unit inserted into the fixing shaft. Hereinafter, a system of introducing to and inserting of a predetermined fixing shaft even in a case where the fixing shaft is shifted from the shaft hole 6361 of the introduction member 636 because of irregular pivoting of the drive switching unit is described with reference to FIGS. 9A to 9C. FIG. 9A is a diagram illustrating a front view in a state in which the fixing shaft is shifted from the shaft hole 6341 of the planetary arm 634, FIG. 9B is a side cross-sectional view, and FIG. 9C is a partially-enlarged cross-sectional view illustrating a state in which the introduction surface 6363 and the first fixing shaft 6111 are put in contact with each other.

In the present embodiment, in a case where the drive switching unit is moved to the third position by the carriage 41, the drive switching unit is removed from the fixing shaft, and thus there is a possibility that the planetary arm 634 orbits (oscillates) because parts are put in contact with each other or the gears mesh with each other during the movement to the third position. Oscillation components may include torsion of a part due to an own weight of the part or transmission of the drive, meshing between the gears, and the like, and a clearance by an amount of a fitting backlash between the parts of the drive switching unit is varied. Then, the planetary arm 634 pivots about the drive shaft 635, and the planetary arm 634, the shaft hole 6341, and the fixing shaft become not coaxial. As a result, the planetary arm 634 may be brought onto the fixing shaft while returning to the first position, or an unintentional fixing shaft may be inserted into the shaft hole of the planetary arm 634 by a next driving operation, and there is a possibility of causing an operation failure.

In the present embodiment, the introduction surface 6363 of the introduction member 636 and each fixing shaft tip have a slope shape, and it is a configuration that allows for the insertion even in a case where the shaft hole centers of the introduction member 636 and the planetary arm 634 are shifted from the fixing shaft center. In the planetary gear 633, the introduction surface 6363 has the inclination in a range from a radius r1 to a radius r2 about the drive shaft 635. The radius r1 is a distance obtained by subtracting a radius of the fixing shaft, a part tolerance, and a margin from a distance between the centers of the drive shaft 635 and the fixing shaft. On the other hand, the radius r2 is a distance obtained by adding the radius of the fixing shaft, the part tolerance, and the margin to the distance between the centers of the drive shaft 635 and the fixing shaft.

Therefore, even in a case where the shaft hole 6361 of the introduction member 636 and the fixing shaft are not coaxial, the drive switching unit is rotated along the introduction surface 6363, and thus the fixing shaft 6111 is inserted into the shaft hole 6361.

An angle (introduction angle α) at which the fixing shaft 6111 can be introduced into the shaft hole 6361 of the introduction member 636 is determined by the following two elements. The first element is an angle a1 formed between a line connecting the axis center of the drive shaft 635 and the center of the shaft hole 6361 of the introduction member 636 and a line that is put in contact with the outermost circle of the introduction surface 6363 of the introduction member 636 from the center axis of the drive shaft 635. The second element is an angle a2 formed between a line connecting the axis center of the drive shaft 635 and the axis center of the fixing shaft and a line that is put in contact with the axis center of the drive shaft 635 and a circle in a tip position of the fixing shaft 6111. That is, since a flat surface portion is formed at a tip of the fixing shaft, the introduction angle α in the present embodiment is α=a1−a2.

In a case where a variation amount due to the oscillation of the planetary arm 634 and the fitting backlash between parts is smaller than a, the fixing shaft 6111 is inserted into the drive switching unit by the introduction member 636. Next, in a case where the carriage 41 is retracted from FIG. 9B, the drive switching unit starts moving in the −x direction by the trigger holder spring 642. In this process, in a case where the center of the shaft hole 6361 of the introduction member 636 is shifted from the center of the fixing shaft 6111, the tip of the fixing shaft 6111 and the introduction surface 6363 are put in contact with each other as illustrated in FIG. 9C. In this process, a load of the trigger holder spring 642 and a slope angle of the introduction surface 6363 are set such that a component Fa in an introduction surface direction in which the fixing shaft 6111 is inserted into the drive switching unit is greater than frictional force Fb that disturbs the insertion of the fixing shaft 6111 into the introduction surface 6363. Thus, the fixing shaft 6111 is inserted into the drive switching unit.

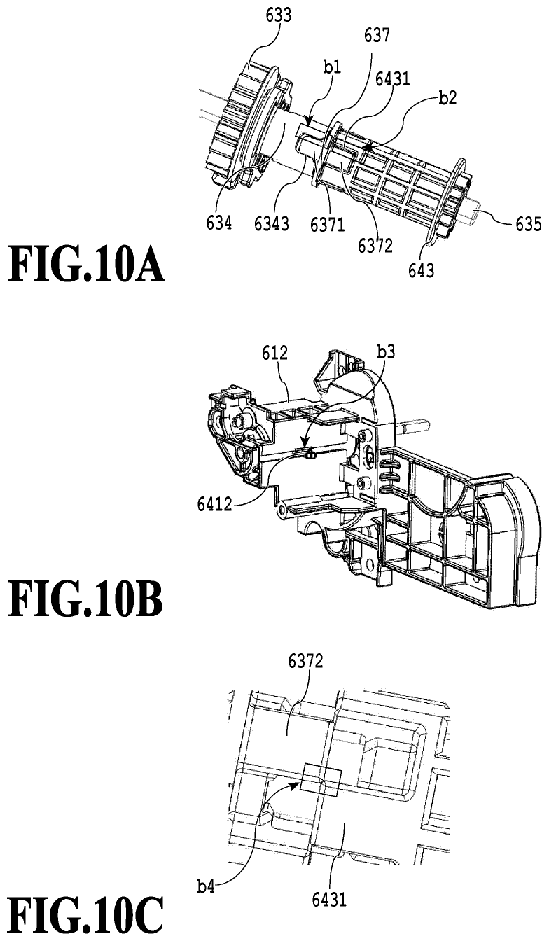

FIGS. 10A to 10C are perspective views illustrating a portion causing oscillation in each member. FIG. 10A illustrates the drive shaft 635 and the drive shaft gear 643, FIG. 10B illustrates the trigger holder 641, and FIG. 10C illustrates the coupling member 637.

As illustrated in FIG. 10A, a comb teeth portion 6431 is provided to the drive shaft gear 643 that is rotated integrally with the drive shaft 635, and a comb teeth portion 6372 meshing with the comb teeth portion 6431 and a comb teeth portion 6371 meshing with a comb teeth portion 6343 of the planetary arm 634 are provided to the coupling member 637. With the corresponding comb teeth portions meshing with each other in the third position, the planetary arm 634 orbits integrally with the drive shaft 635.

Here, an oscillation component that occurs in a clearance between the comb teeth portion 6343 of the planetary arm 634 and the comb teeth portion 6371 of the coupling member 637 is b1, and an oscillation component that occurs in a clearance between the comb teeth portion 6372 of the coupling member 637 and the comb teeth portion 6431 of the drive shaft gear 643 is b2. There is a possibility that oscillation occurs in the oscillation component b1 and the oscillation component b2.

Additionally, as illustrated in FIG. 10B, there is a possibility that oscillation occurs in an oscillation component b3 that is a clearance between the locking unit 6412 of the trigger holder 641 and the drive cover 612.

Moreover, as illustrated in FIG. 10C, tip corner portions of the comb teeth portion 6372 of the coupling member 637 and the comb teeth portion 6431 of the drive shaft gear 643 have a slope shape. The slope shape increases a contact area in a case where the comb teeth portions are put in contact with each other and thus relaxes stress and suppresses abrasion of the other portion. However, in a case where the comb teeth portions are put in contact with each other at the slope portions, there is a possibility that an angle of the slope becomes an oscillation component b4 and causes oscillation of the planetary arm 634.

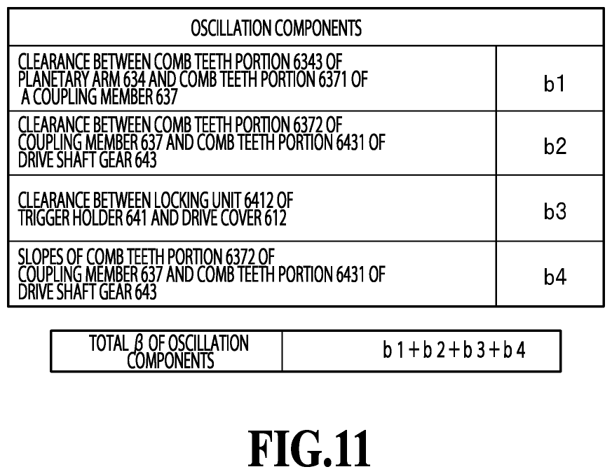

FIG. 11 is a table illustrating a list of the oscillation components b1 to b4 illustrated in FIGS. 10A to 10C. In a case where an oscillation angle of the planetary arm 634 obtained from a total β of the oscillation components=b1+b2+b3+b4 is smaller than the introduction angle α described in FIG. 9A, it is possible to properly introduce the planetary arm 634. Therefore, in the present embodiment, each part is formed so as to obtain that the introduction angle α>the oscillation angle of the planetary arm 634 obtained from the oscillation components β. Additionally, the above-mentioned introduction angle α and the oscillation components β are for a case of the configuration of the parts in the present embodiment, and it is not limited thereto. In a case of another configuration, it is desirable to perform calculation as needed. The oscillation angle of the planetary arm 634 obtained from the total β of the oscillation components=b1+b2+b3+b4 can also be said as an angle that is obtained from a backlash in the gears from the drive shaft 635 to the sun gear 632.

In the present embodiment, the image printing apparatus is described; however, it is possible to apply the present invention to the drive switching mechanism of the present embodiment, an apparatus including the drive switching mechanism, and the like.

Thus, in the drive switching operation, the position of the planetary gear 633 is not fixed by the fixing shaft 6111 except in the first position and the second position. Therefore, it is possible to provide a drive switching mechanism and an image printing apparatus that can downsize the apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-124481, filed Jul. 31, 2023, which is hereby incorporated by reference wherein in its entirety.

What is claimed is:

1. A drive switching mechanism, comprising:
a drive shaft that is rotated by a driving source;
a driven unit that includes a fixing shaft to which driving force of the drive shaft is transmitted;
a drive switching unit that switches transmission of the driving force of the drive shaft to the driven unit by being moved in a thrust direction of the drive shaft; and
a planetary gear that is provided to the drive switching unit, can orbit around the drive shaft in a case of not being engaged with the fixing shaft, and can transmit the driving force of the drive shaft to the driven unit while being engaged with the fixing shaft, wherein
the drive switching unit can be moved to a first position in which the driving force of the drive shaft is transmitted to the driven unit while being engaged with the fixing shaft, a second position in which the driving force of the drive shaft is not transmitted to the driven unit while being engaged with the fixing shaft, and a third position in which the planetary gear can orbit while not being engaged with the fixing shaft, and
the drive switching unit passes through the third position in a case where the planetary gear is not allowed to orbit while moving from the second position to the first position.

2. The drive switching mechanism according to claim 1, further comprising:
a sun gear that is arranged on the same axis as the drive shaft and rotated integrally with the drive shaft; and
a planetary arm that holds the planetary gear so as to be able to orbit around the sun gear.

3. The drive switching mechanism according to claim 1, comprising:
a plurality of the driven units.

4. The drive switching mechanism according to claim 2, wherein
the planetary gear includes a shaft hole into which the fixing shaft can be inserted, and the shaft hole includes an inclined portion that is narrowed in an insertion direction of the fixing shaft.

5. The drive switching mechanism according to claim 4, wherein
the planetary gear includes an introduction member, and the inclined portion is provided to the introduction member.

6. The drive switching mechanism according to claim 4, wherein
an angle between the inclined portion and a center axis of the fixing shaft is greater than an angle at which the planetary arm oscillates due to a backlash in a gear from the drive shaft to the sun gear.

7. The drive switching mechanism according to claim 1, wherein
the drive switching unit is moved by movement of a carriage.

8. The drive switching mechanism according to claim 7, wherein
along with the movement of the carriage, the drive switching unit starts moving by a spring.

9. An image printing apparatus, comprising:
a driving source;
a carriage that is moved with a printing head mounted thereon;
a drive shaft that is rotated by the driving source;
a driven unit that includes a fixing shaft to which driving force of the drive shaft is transmitted;
a drive switching unit that switches transmission of the driving force of the drive shaft to the driven unit by being moved in a thrust direction of the drive shaft along with the movement of the carriage; and
a planetary gear that is provided to the drive switching unit, can orbit around the drive shaft in a case of not being engaged with the fixing shaft, and can transmit the driving force of the drive shaft to the driven unit while being engaged with the fixing shaft, wherein
the drive switching unit can be moved to a first position in which the driving force of the drive shaft is transmitted to the driven unit while being engaged with the fixing shaft, a second position in which the driving force of the drive shaft is not transmitted to the driven unit while being engaged with the fixing shaft, and a third position in which the planetary gear can orbit while not being engaged with the fixing shaft, and
the drive switching unit passes through the third position in a case where the planetary gear is not allowed to orbit while moving from the second position to the first position.

10. The image printing apparatus according to claim 9, wherein
the drive shaft is a conveyance roller that conveys a printing medium, and
the driven unit is a plurality of driven units including a feeding unit that feeds the printing medium to a position in which the printing head can perform printing and a maintenance unit that performs maintenance of the printing head.
